(19) United States
(12) Patent Application Publication
(10) Pub. No.: US 2026/0342766 A1
(43) Pub. Date: Oct. 29, 2026

(54) SYSTEMS AND METHODS FOR MONITORING NETWORK ACTIVITY THROUGH MULTI-STAGE MACHINE LEARNING DATA ANALYSIS

(71) Applicant: Expedia, Inc., Seattle, WA (US)

(72) Inventors: Anirudh Kamalapuram Muralidhar, Seattle, WA (US); Andrew Charles Reuben, Seattle, WA (US); Stephen McDonald, Seattle, WA (US)

(73) Assignee: Expedia, Inc., Seattle, WA (US)

(21) Appl. No.: 19/661,426

(22) Filed: Apr. 28, 2026

Related U.S. Application Data
(60) Provisional application No. 63/796,769, filed on Apr. 29, 2025.

(51) Int. Cl. H04L 9/40

(52) U.S. Cl. CPC H04L 63/0245

(57) ABSTRACT

Systems, methods, and computer-readable media for monitoring network activity are provided. A system includes at least one processor configured to: receive data regarding a plurality of communications sessions; analyze, using a first machine learning model, the data to identify a characteristic of at least one of the plurality of communication sessions; flag the at least one communication session based on identifying the characteristic of the at least one communication sessions; filter at least some data from the at least one communication session; analyze, using a second machine learning model, the filtered at least some data from the at least one communication session to determine an intent; responsive to the determined intent satisfying a predefined attribute, initiate one or more actions; and responsive to the determined intent not satisfying the predefined attribute, remove the flag on the at least one communication session.

### CROSS-REFERENCE TO RELATED PATENT APPLICATION

This application claims the benefit of and priority to U.S. Provisional Application No. 63/796,769, filed Apr. 29, 2025, which is incorporated herein by reference in its entirety and for all purposes.

### TECHNICAL FIELD

Embodiments and aspects of the present disclosure relate generally to systems and methods for monitoring network activity through utilization of at least one machine learning model data analysis.

### BACKGROUND

Network activity can be susceptible to undesirable fraudulent activity. Network activity can include engagement on websites or other networked platforms, such as application-based platforms. Specific types of activity can include communication sessions. However, it is computationally intensive to review content from all communication sessions. Further, monitoring network activity generally is a very computationally intensive endeavor. Techniques to minimize the computation burden are desired.

### SUMMARY

One embodiment relates to a system for monitoring network activity. In operation, a multi-stage machine learning model architecture may be used to monitor network activity. The system includes: one or more non-transitory computer readable media storing instructions thereon that, when executed by one or more processors, cause the one or more processors to: receive data regarding a plurality of communications sessions; analyze, using a first machine learning model, the data to identify at least one characteristic of at least one of the plurality of communication sessions; flag the at least one communication session based on identifying the at least one characteristic of the at least one communication sessions; filter at least some data from the at least one communication session of the plurality of communication sessions; subsequent to filtering the at least some data from the at least one communication session, analyze, using a second machine learning model, the filtered at least some data from the at least one communication session of the plurality of communication sessions to determine an intent of the at least one communication session; responsive to the determined intent of the at least one communication session satisfying a predefined attribute, initiate one or more actions; and responsive to the determined intent of the at least one communication session not satisfying the predefined attribute, remove the flag on the at least one communication session.

Another embodiment relates to a method for monitoring network activity. The method includes: receiving, by one or more processors, data regarding a plurality of communications sessions; analyzing, by the one or more processors, using a first machine learning model, the data to identify at least one characteristic of at least one of the plurality of communication sessions; flagging, by the one or more processors, the at least one communication session based on identifying the at least one characteristic of the at least one communication sessions; filtering, by the one or more processors, at least some data from the at least one communication session of the plurality of communication sessions; subsequent to filtering the at least some data from the at least one communication session, analyzing, by the one or more processors, using a second machine learning model, the filtered at least some data from the at least one communication session of the plurality of communication sessions to determine an intent of the at least one communication session; responsive to the determined intent of the at least one communication session satisfying a predefined attribute, initiating, by the one or more processors, one or more actions; and responsive to the determined intent of the at least one communication session not satisfying the predefined attribute, removing, by the one or more processors, the flag on the at least one communication session.

Still another embodiment relates to one or more non-transitory computer readable media storing instructions thereon that, when executed by one or more processors, cause the one or more processors to perform operations including: receiving data regarding a plurality of communications sessions; analyzing, using a first machine learning model, the data to identify at least one characteristic of at least one of the plurality of communication sessions; flagging the at least one communication session based on identifying the at least one characteristic of the at least one communication sessions; filtering at least some data from the at least one communication session of the plurality of communication sessions; subsequent to filtering the at least some data from the at least one communication session, analyzing, using a second machine learning model, the filtered at least some data from the at least one communication session of the plurality of communication sessions to determine an intent of the at least one communication session; responsive to the determined intent of the at least one communication session satisfying a predefined attribute, initiating one or more actions; and, responsive to the determined intent of the at least one communication session not satisfying the predefined attribute, removing the flag on the at least one communication session.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a block diagram of a system for multi-stage, particularly two stage, data analysis for monitoring network activity using at least one machine learning model, according to an example embodiment.

FIG. 2 is a block diagram of the data analysis circuit of the system of FIG. 1, according to an example embodiment.

FIG. 3A is a flow diagram of a method of multi-stage data analysis to monitor network activity and detect one or more characteristics of the network activity, according to an example embodiment.

FIG. 3B is a flow diagram of a method of multi-stage data analysis to monitor network activity and detect policy violations, according to an example embodiment.

FIG. 4 is a graph illustrating rates of false positive detection using multi-stage data analysis , according to an example embodiment.

FIG. 5 is a flow diagram of a method of monitoring network activity using a multi-stage, particularly a two-stage, data analysis using at least one machine learning model, according to an example embodiment.

### DETAILED DESCRIPTION

Following herein below are systems, methods, and computer-readable media for monitoring network activity and, particularly communication sessions by multiple connected devices, by analyzing communication sessions using a multi-stage machine learning data analysis approach.

With the increased networked world, fraudsters are constantly trying to infiltrate computer-based systems. Many computer-based systems may prescribe various policies for use, but monitoring compliance is an extremely labor intensive process. In particular, manual methods of data analysis can be inefficient, resource-intensive, and/or prone to human error, particularly when large volumes of data are being analyzed. Thus, manual network activity monitoring may be inefficient and/or incapable of identifying fraudsters and/or policy violations. Similarly, some automated methods of data analysis may be unable to detect obfuscated or sophisticated methods of fraudulence, scams, and/or policy violations. These methods may face a tradeoff between capturing too few instances of a particular objective of interest and generating a large number of false positives. For example, some data analysis methods may fail to identify all instances of fraud within a large dataset, which can lead to increased occurrences of fraud. Alternatively, these data analysis methods may identify a piece of data as being fraudulent when fraud does not actually exist within that data.

The systems, computer-readable media, and methods described herein are operable to monitor network activity to identify potential undesirable activity (e.g., one or more policy violations) and remediate the identified undesirable network activity. As described herein, a system may utilize a multi-stage process (e.g., a two stage process) to analyze data to identify the potentially undesirable network activity. At least one of the stages may utilize one or more machine learning models. In particular and described herein, the multi-stage system architecture may be operable to monitor communication sessions, such as between users of a communication platform provided by a provider institution computing system and/or between users/customers and the provider institution computing system itself (and/or between the three parties). Each communication session may be analyzed by the provider computing system using a multi-stage architecture. In particular, a first machine learning model may be used to analyze the communications, and a second model machine learning model may be used to analyze communication(s) flagged for further analysis by the first machine learning model. The first machine learning model may identify at least one characteristic of the communication session that corresponds to a predefined variable, such as a word or phrase. Upon identifying that the communication session includes the characteristic, the first machine learning model may flag the communication session. Flagging the communication session may cause the communication session to undergo additional analysis by the second machine learning model. Specifically, the second machine learning model may analyze the communication session to determine an intent of the communication session. If the intent of the communication session satisfies a predefined attribute, one or more actions may be initiated. If the intent does not satisfy the predefined attribute, the flag set by the first machine learning model may be removed and analysis or handling of the communication session may cease. The intent satisfying the predefined attribute may indicate that the communication session(s) includes or indicates potential undesirable activity. Accordingly, initiating the one or more actions may cause the undesirable activity or potentially undesirable activity to be mitigated or remediated, which may improve data security.

As will be described herein, the first machine learning model may be a smaller, less costly model that is optimized for speed, reduced computing processes, and high recall. The second machine learning model may be a large language model that analyzes data more thoroughly than the first machine learning model, thereby improving precision associated with detecting relevance of the data to the objective. Analysis by large languages models may be more computationally expensive than analysis by the first machine learning models.

The use of multiple models in the multi-stage architecture provides several technical benefits and advantages. Specifically, multiple models, each configured to analyze communication sessions in a different manner, can enhance detection accuracy. For example, a single model may sacrifice performance in one aspect of data analysis by having an improved performance in another aspect of data analysis. Combining the use of multiple models can allow for improved performance for all or most types of data analysis, as each stage or model may be optimized to perform a different type of data analysis. Additionally, a multi-stage architecture can improve analysis of particular edge cases. For example, some communication sessions may utilize complex methods to perform undesirable network activities. Analysis of these communication sessions by multiple stages and models may increase a likelihood that these complex methods are detected and the undesirable network activity is remediated.

The multi-stage architecture may implement the stages in a particular order to cause the communication sessions to be analyzed in an efficient manner. For example, a first machine learning model may first analyze communication sessions to maximize recall while also identifying certain communication sessions as not including undesirable network activity. That is, the first machine learning model may maximize the number of communication sessions that are identified to include particular characteristics and flagged so that the number of communication sessions analyzed by subsequent stages in the architecture is also maximized without causing subsequent stages to analyze communication session that are likely to not include undesirable network activity. A second or subsequent stage may analyze the flagged communication sessions more thoroughly. Implementing the multi-stage architecture such that the first stage filters out communication sessions that are likely to not include undesirable activity may improve computing performance because increased computing resources are not used to thoroughly analyze, by the second machine learning model, these communication sessions. Further, this implementation of the multi-stage architecture also ensures that communication sessions that may include undesirable activity are thoroughly analyzed by the second machine learning model and are not incorrectly identified as not including undesirable activity.

As will be described herein, the first machine learning model (e.g., first stage) may be a faster model that perform a less thorough analysis of the communication sessions relative to the second machine learning model (e.g., second stage). To avoid increased costs, computational workloads, and latency associated with analyzing large datasets by large language models, data is first analyzed by the less resource-heavy first machine learning model. For example, the first machine learning model may be a natural language processor (NLP) that quickly analyzes communication sessions to determine, in some examples, whether the communication session includes particular undesirable triggers (e.g., words and/or phrases). If the communication session does not include such words or phrases, the communication session may cease further analysis. Only communication sessions determined to potentially include undesirable activity by the first machine learning model are passed to the second machine learning model (e.g., the LLM). This faster, less thorough analysis may be beneficial because the first machine learning model analyzes larger amounts of data relative to subsequent stages of the architecture, thereby reserving computing resources.

The second machine learning model (e.g., second stage) may be a slower model than the first machine learning model that requires relatively more computing resources. For example, the second machine learning model may be a large language model (LLM). The second machine learning model may maximize or substantially maximize precision. For example, the second machine learning model may identify false positives made by the first machine learning model. In some embodiments, the second machine learning model may determine a context or intent of the communication session. This may be beneficial in improving accuracy of the multi-sage architecture because communication sessions are analyzed more closely than by the first machine learning model. Additionally, because fewer communication sessions are analyzed by the more computationally expensive LLM, resources and costs associated with analyzing every piece of data are reduced, thereby optimizing computing resources because computationally intensive analysis is performed only on communication sessions determined to be likely to have undesirable activity (e.g., due to identification of particular characteristics by the first machine learning model).

Before turning to the Figures, which illustrate certain example embodiments in detail, it should be understood that the present disclosure is not limited to the details or methodology set forth in the description or illustrated in the Figures. It should also be understood that the terminology used herein is for the purpose of description only and should not be regarded as limiting.

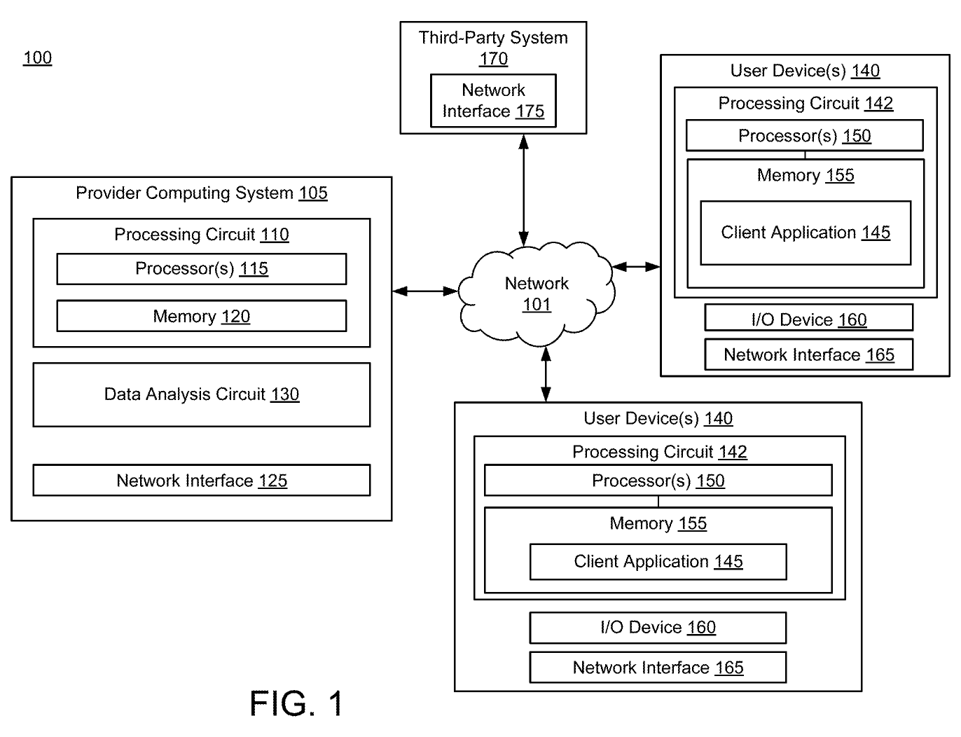

FIG. 1 illustrates an example system 100 for data analysis, according to an example embodiment. As shown, the system 100 includes a provider computing system 105 coupled to one or more user devices 140 and one or more third-party systems 170 via a network 101. As will be discussed herein, the provider computing system 105 may receive information regarding certain network activity, particularly a plurality of communication sessions, and utilize a plurality of machine learning models to analyze the communication sessions. In this regard, the network activity may include communication sessions. Communication sessions may be network-based communication sessions between various computing devices. The communication sessions are analyzed to identify a variety of characteristics and selectively determine an intent of the communication sessions. Based at least in part on the determined intent of at least some communication sessions, the provider computing system 105 can be used to detect communication sessions that violate or may violate one or more policies of the provider and/or are otherwise indicative of fraud, spam, suspicious behavior (e.g., payment fraud, suspicious account logins, or market manipulation). In response, the provider computing system 105 may generate and provide one or more remediation actions to thwart the potentially unwanted network activity identified.

The provider computing system 105 may be a computing system associated with a provider entity. The provider organization or entity may be a provider of goods and/or services (e.g., an online travel agency). In this example, the provider entity is a travel services/experiences provider, such as a travel agency or travel broker (e.g., a company that allows users to book travel services provided by other companies), which provides and maintains one or more accounts on behalf of the user. The provider may be a transportation provider (e.g., airline, car or rental vehicle service, rideshare/taxi service etc.), a lodging provider (e.g., hotel, rental property, cruise, etc.), an experience provider (e.g., theme parks, concerts, shows, events, excursions, etc.), or any combination thereof. In the example shown, the provider is a travel or experience booking agency that provides or enables a variety of experiences by interfacing/communicating with other providers (e.g., lodging providers, airline providers, etc.). As described herein, in some implementations, the provider computing system 105 may be structured or configured to analyze communication sessions using a multi-stage machine learning model process to identify one or more characteristics and/or an intent of the communication sessions that indicate that the communication session has an associated attribute, such as a provider policy violation.

The provider computing system 105 can be structured as one or more backend computing systems including one or more servers and other computing components, in some embodiments. The provider computing system 105 can include at least one processing circuit 110, which may, as an example, include at least one processor 115 and at least one memory 120. The provider computing system 105 may include one or more servers that include one or more of the processors and/or memory components described above and herein. The memory 120 can store computer-executable and/or computer readable instructions thereon that, when executed by the processor 115, cause the processor 115 to perform one or more of the operations described herein. The processor 115 may include a microprocessor, an application-specific integrated circuit (ASIC), a field-programmable gate array (FPGA), a graphics processing unit (GPU), a tensor processing unit (TPU), etc., and/or combinations thereof. The memory 120 may include, but is not limited to, electronic, optical, magnetic, or any other storage or transmission device capable of providing the processor 115 with program instructions. The memory 120 may further include a magnetic disk, memory chip, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The provider computing system 105 can include one or more computing devices or servers that can perform various of the operations or functions described herein. The memory 120 may store a data analysis circuit 130, which will be described in greater detail herein.

In the example shown, the provider computing system 105 (e.g., the memory 120) may include a data analysis circuit 130 that is configured to analyze data using a plurality of machine learning models. In some embodiments, the processing circuit 110 is configured or structured to perform the operations described herein with respect to the data analysis circuit 130.

In some implementations, various components and/or systems of the data analysis circuit 130 may be configured to analyze communication sessions using a plurality of machine learning models in a multi-stage (e.g., two-stage) process. For example, a first machine learning model of the data analysis circuit 130 receives a plurality of communication sessions and analyzes each communication session to identify whether the communication session includes or contains one or more characteristics (e.g., words or phrases). Each communication session determined to include the one or more characteristics is flagged and subsequently analyzed by a second machine learning model. The second machine learning model is configured to analyze the flagged communication session to identify an intent of the communication session. As stated above, the data analysis circuit 130 uses the identification of the characteristics and/or intent identify that the communication session includes information that satisfies a predefined attribute (e.g., identify a policy violation, etc.). The satisfaction of the predefined attribute may cause to the data analysis circuit 130 to initiate one or more actions, such as generating an explanation of why the communication session satisfies the attribute.

The provider computing system 105 can include a network interface 125. In some instances, the network interface 125 includes, for example, program logic and any associated hardware components (e.g., transceivers, ethernet cards, etc.) that couple the provider computing system 105 to the network 101. The network interface 125 may facilitate secure communications between the provider computing system 105 and each of the user device(s) 140 and third-party system(s) 170 (e.g., by using one or more encryption techniques to shield communications). The network interface 125 also facilitates communication with other entities, such as other providers of goods and/or services (e.g., airline computing systems, lodging computing systems, music event computing systems that are associated with concert arenas, etc.).

The network 101 can include any combination of wired and/or wireless networks. Thus, the network 101 may include packet-switching computer networks such as the Internet, local, wide, metro, or other area networks, intranets, satellite networks, other computer networks such as voice or data mobile phone communication networks, or combinations thereof. The provider computing system 105 of the system 100 can communicate via the network 101 with one or more computing devices, such as the one or more user devices 140 and the one or more third-party systems 170. The network 101 may be any form of computer network that can relay information between the provider computing system 105, the one or more user devices 140, the one or more third-party systems 170, and one or more information sources, such as web servers or external databases, amongst others. In some implementations, the network 101 may include the Internet and/or other types of data networks, such as a local area network (LAN), a wide area network (WAN), a cellular network, a satellite network, or other types of data networks. The network 101 may also include any number of computing devices (e.g., computers, servers, routers, network switches, etc.) that are configured to receive or transmit data within the network 101.

As alluded to above, the network 101 may include any number of hardwired or wireless connections. Any or all of the computing devices described herein (e.g., the provider computing system 105, the one or more user devices 140, the one or more third-party systems 170, etc.) may communicate wirelessly (e.g., via Wi-Fi, cellular communication, radio, etc.) with a transceiver that is hardwired (e.g., via a fiber optic cable, a CAT5 cable, etc.) to other computing devices in the network 101. Any or all of the computing devices described herein (e.g., the provider computing system 105, the one or more user devices 140, the one or more third-party systems 170, etc.) may also communicate wirelessly with the computing devices of the network 101 via a proxy device (e.g., a router, network switch, or gateway). In some embodiments, a wired or a combination of wired and/or wireless connections may be used to enable communicable coupling.

The system 100 is shown to include a plurality of user devices 140. The user device 140 may be owned by, managed by, and/or otherwise associated with a user. In the example shown whereby the provider is a travel experience provider (e.g., an online travel agency), the user may be a customer. For example, the user may be a traveler that uses the products and/or services of the provider entity. The user or traveler may be an individual, a representative of an entity, and/or another type of user. The user may view or browse a website and/or mobile application associated with the provider. In one embodiment, the user may be viewing the website or mobile application associated with the provider to, for example, view properties, view flight options, view experiences (e.g., concerts, bungee jumping, etc.), and book one or more experiences (e.g., book lodging, book a flight, book a show such as a sports events, etc.). In another embodiment, the user may be a provider of a vacation rental property that is listed on a website associated with the travel experience provider. In various embodiments, a vacation rental property provider or owner may communicate with a user of the travel experience provider that is searching for a rental property to book for a vacation.

In one example, a first user is a consumer of a property listed by the provider computing system 105 and a second user is the property owner (host property). This arrangement may be for vacation rentals.

The user device 140 may be one or more computing devices that can perform various operations as described herein. For example, in some implementations, the user device 140 may be or may include, for example, a desktop or laptop computer (e.g., a tablet computer), a smartphone, a wearable device (e.g., a smartwatch), a personal digital assistant, and/or any other suitable computing device. In the example shown, the user device 140 is structured as a computing device, namely a mobile device (e.g., a smartphone).

Each of the user devices 140 can include at least one processing circuit 142, at least one processor (e.g., processor(s) 150), and at least one memory (e.g., memory 155). The memory 155 may, as an example, include at least one client application (e.g., client application 145). In some implementations, one or more of the user devices 140 can access various functions of the provider computing system 105 through the network 101. For example, the user device 140 can access one or more functions of the provider computing system 105 via the client application 145 of the user device 140 that is configured to display various user interfaces to the user device 140 via the network 101.

The client application 145 can be coupled to and supported, at least partly, by the provider computing system 105. For example, in operation, the client application 145 can be communicably coupled to the provider computing system 105 and may perform certain operations described herein. In some embodiments, the client application 145 includes program logic stored in a system memory (e.g., memory 155) of the user device 140. In such arrangements, the program logic may configure a processor (e.g., processor(s) 150) of the user device 140 to perform at least some of the functions discussed herein with respect to the client application 145 of the user device 140. In the example shown, the client application 145 may be downloaded from an application store, stored in the memory 155 of the user device 140, and selectively executed by the processor(s) 150. In other embodiments, the client application 145 may be hard-coded into the user device 140. In still various other embodiments, the client application 145 is a web-based application.

As alluded to above, the client application 145 may be provided by the provider associated with the provider computing system 105 such that the client application 145 supports at least some of the functionalities and operations described herein with respect to the provider computing system 105. In this way, the client application 145 may also be referred to as a provider institution client application or provider client application. In some embodiments, the client application 145 may be accessed and executed by the processor(s) 150 responsive to receiving various credentials of a user to access the client application 145 (e.g., a username, a password, a pin code, a biometric such as a facial scan or a fingerprint, a combination thereof, etc.).

In some instances, the client application 145 may additionally be coupled to the third-party system(s) 170 (e.g., via one or more application programming interfaces (APIs) and/or software development kits (SDKs)) to integrate one or more features or services provided by the third-party system(s) 170. In some instances, the third-party system(s) 170 may alternatively and/or additionally provide services via a separate client application 145. For example, the client application 145 may initiate an API call to the third-party system 170 to retrieve API information related to reviews for the property left on a website not associated with the provider.

The client application 145 may have different functionalities for the first and second users described above. For example, the second user may be provided with the ability to set price, stay availability, and other attributes regarding the host property while the first user can simply select the property and book the property for a stay.

The processor(s) 150 can include a microprocessor, an ASIC, an FPGA, a GPU, a TPU, etc., or combinations thereof. The memory 155 can store processor-executable instructions that, when executed by the processor(s) 150, cause the processor(s) 150 to perform one or more of the operations described herein. The memory 155 can include, but is not limited to, electronic, optical, magnetic, or any other storage or transmission device capable of providing the processor 150 with program instructions. The memory 155 can further include a memory chip, ROM, RAM, EEPROM, EPROM, flash memory, optical media, or any other suitable memory from which the processor(s) 150 can read instructions. The instructions can include code from any suitable computer programming language.

The user device 140 is further shown as including an I/O device 160 and a network interface 165. The I/O device 160 can include various components for receiving inputs, providing outputs, and/or receiving and providing inputs and outputs, respectively, to a user of the user device 140. For example, the I/O device 160 can include a display screen such as a touchscreen, a mouse, a button, a keyboard, a microphone, a speaker, an accelerometer, actuators (e.g., vibration motors), any combination thereof, etc. The I/O device 160 may also include circuitry/programming/etc. for operating such components. The I/O device 160 thereby enables communications to and from a user, for example communications relating to initiated actions relating to the analyzed data as described in further detail herein.

The network interface 165 includes, for example, program logic and various devices and/or components and systems (e.g., transceivers, etc.) that couple the user device 140 to the network 101. The network interface 165 facilitates secure communications between the user device 140 and each of the provider computing system 105 and/or the third-party system 170. The network interface 165 also facilitates communication with other entities, such as other providers of goods and/or services.

The system 100 is shown to include the third-party system 170 (although only one is shown, there could be a plurality or, in some embodiments, none). The third-party system 170 may be a computing system and may be owned by, managed by, and/or otherwise associated with a third-party or third-party entity relative to the provider. For example, the third-party entity may be or may include various goods and/or services provider entities including, but not limited to, a lodging provider (e.g., hotel, rental property, cruise, etc.), a transportation provider (e.g., airline, car service, etc.), an experience provider (e.g., theme parks, concerts, shows, events, excursions, etc.), or any combination thereof. In some examples and rather than two users, a user of the user device may communicate with a third-party host property owner who is not another user but an entity.

In the example shown, the system includes a plurality of third-party systems 170. Thus, the system 100 may include a third-party system 170 associated with a lodging provider, another third-party system 170 associated with a transportation provider, and another third-party system 170 associated with an experience provider. The provider computing system 105 may selectively receive information or data from each of the third-party systems 170. The provider computing system 105 may additionally communicate with the third-party systems 170 to make bookings, such as to reserve experiences on behalf of the traveler/user. The third-party system 170 includes a respective network interface 175 to facilitate exchanging data with the provider computing system 105 and/or the user device 140 through the network 101. The third-party system 170 may include one or more servers. The third-party system 170 may include one or more APIs and/or SDKs associated with the third-party entity for exchanging data with the provider computing system 105 and/or the user device 140, as described herein.

The provider computing system 105 is shown to include a data analysis circuit 130. The data analysis circuit 130 may retrieve or receive indications of network activity. Network activity may include a plurality of communication sessions occurring over or across the network 101. A communication session may be any exchange of data or information between two or more parties (e.g., via the user devices 140) for a period of time. In some embodiments, the communication session may be a one way communication session. For example, the communication session may include data transmitted from a first party to a second party without the second party transmitting data to the first party. As such, some communication sessions may include a data exchange between a user and a computing system. For example, the provider computing system 105 may receive information about a user of the provider computing system without the provider computing system 105 transmitting information to the user. In other embodiments, the communication session may be a two way communication session. For example, the communication session may include data transmitted to and from each party (e.g., a first party transmits data to a second party and vice versa). The transmitted data may be in any format, including text-based, video-based, audio-based, image-based, etc. In some embodiments, the data may be formatted as a structured or other type of dataset. In various embodiments, the data analysis circuit 130 may receive data that is not part of a communication session but is rather data that exists within a system (e.g., the data analysis circuit 130 receives data that is not transmitted or communicated but is stored within a system). As such, reference is made throughout to a communication session, but it should be understood that the systems and methods described herein may refer to data occurring outside of a communication session.

In various embodiments, the communication sessions may be or include the exchange of message data. The message data may include data or information pertaining to one or more of the users included in the communication session. For example, the message data may include messages pertaining to travel-related services, such as a vacation rental property, a hotel, transportation, or experiences. As an example, a communication session may be between a rental property provider and a customer booking the rental property via a listing on the website of a travel experience provider. In other implementations, the message data may include, for example, any other message data between two or more parties, payment data (e.g., transactions), account data (e.g., account logins and associated data), user preferences, user behavior, or any other type of data. The data analysis circuit 130 may analyze each communication session using a first machine learning model.

In some embodiments, the message data is exchanged in the form of textual messages between two or more parties. For example, messages may be exchanged in the form of text messages, chat messages on a chat-based system via one or more applications (e.g., client applications 145), email messages, and the like. In various embodiments, the communication sessions may be or include the exchange of additional or alternative data formats. For example, communication sessions may include the exchange of audio data, video data, image data, and the like. The types of data exchanged in these formats may be the same as or similar to those examples listed above with respect to text data. For example, photos and videos of a property rental may be exchanged between two parties that is communicated via a chat-based messaging system on the client application 145. As a further example, a communication session may include the exchange of structured data and/or other datasets. In various other embodiments, the data analysis circuit 130 may receive and analyze text data, image data, video data, structured data, etc., that is not part of a communication session.

As discussed above, reference is made throughout to analysis of text-based signals (e.g., text-based communications, etc.). However, it should be understood that the data analysis circuit 130 and its components may be modality-agnostic and may be able to analyze non-text signals. For example, the data analysis circuit 130 may analyze image-based data (e.g., images may be exchanged and the data analysis circuit 130 may analyze the content of the communicated images), structured data, and/or other datasets that may be used for classifier-driven detection. For example, the data analysis circuit 130 may be compatible with and analyze binary, multi-label, and/or multi-class classifiers (or other types of data).

The data analysis circuit 130 may include a first stage (e.g., a first machine learning model) and a second stage (e.g., a second machine learning model). The first stage/first machine learning model may be optimized to analyze data for recall and the second stage/machine learning model may be optimized to analyze data for precision. For example, the first machine learning model may identify one or more characteristics (e.g., words or phrases corresponding to a particular variable that indicates an attribute or feature of the communication session) of each received communication session. The data analysis circuit 130 may then flag each communication session determined to include the one or more characteristics. These flagged communication sessions may then be analyzed by a second machine learning model to determine an intent of each communication session. Upon determining that an intent of the communication session satisfies a predefined attribute (e.g., undesirable activity), the data analysis circuit 130 may initiate one or more actions. In an example in which the communication session is messages between a rental property provider and a customer, the action may be identifying that a message from the rental property provider to the customer includes certain data (e.g., text) that is a violation of a policy the travel experience provider, and generating an explanation of why the intent of the communication session satisfies the predefined attribute. The data analysis circuit 130 may store the communication session for subsequent transmittal (e.g., to a user via a client application, such as the client application 145 associated with a system operating device of the user, such as the user device 140).

Reference is made throughout to communication sessions, and particularly to communication sessions between vacation rental providers and travelers. However, it should be understood that the systems and methods discussed herein may be applied to any scenario which utilizes or implements a plurality of classification-based machine learning models. For example, reference is made herein to identifying policy violations using a multi-stage machine learning model system. However, the systems, computer-readable media, and methods described herein may apply to other trust-enforcement scenarios or text-classification scenarios, such as using a multi-stage machine learning system to identify denied entry to a location for certain users, enforce shared-space policies, detect fraud, authenticate log-in attempts, determine levels of user access to various systems, and/or any other system in which is may be beneficial to use a first model to filter at least some portion of data or information being analyzed and subsequently use a second model to identify false positives within the filtered data or information.

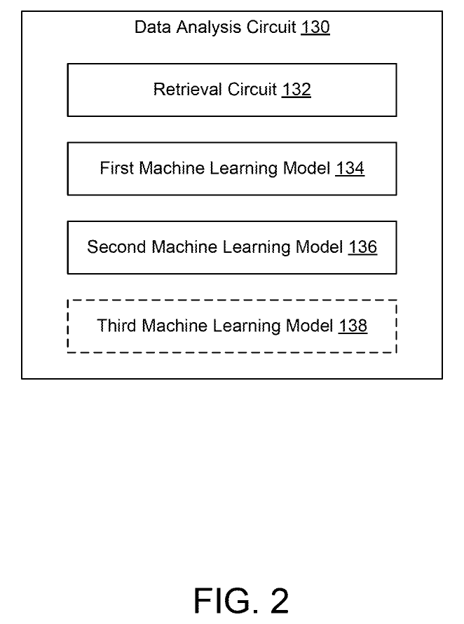

Referring now to FIG. 2, a block diagram of the data analysis circuit 130 is shown, according to an example embodiment. The data analysis circuit 130 may analyze communication sessions and/or other types of data using a plurality of machine learning models to initiate one or more actions. In one example, the data analysis circuit 130 may analyze messages communicated on a platform supported by the provider computing system 105. For example, a rental property provider may list a rental property on a website of the provider, and a potential renter of the property may view the property via, for example, the client application 145. The rental property provider and the potential renter may communicate about the rental property. The data analysis circuit 130 may therefore analyze messages between the rental property provider and the potential renter to determine whether one or more messages from one party (e.g., the rental property provider) to the other party (e.g., the potential renter) includes undesirable activity, such as a violation of a rule or policy associated with the provider of the provider computing system 105. For example, rental property providers may send messages encouraging a potential renter to complete a transaction off of the platform supported by the provider computing system 105 (e.g., the application-based communication session). This may be hazardous for the potential renter and may be against a policy of provider (e.g., the provider of the website on which the rental property is listed).

In another example, the data analysis circuit 130 may analyze communication session (e.g., messages) to identify potential fraudulence (e.g., spam or scam messages, fraudulent transactions, fraudulent accounts, etc.). The data analysis circuit 130 may also analyze communication session to determine or classify a sentiment of one or more communication sessions (e.g., messages). Similarly, the data analysis circuit 130 may analyze communication sessions to identify offensive content (e.g., profanity, hate speech, harassment, etc.), fraudulent reviews or other content, and the like.

The data analysis circuit 130 may include at least a retrieval circuit 132, a first machine learning model 134, and a second machine learning model 136. Optionally, the data analysis circuit 130 may also include a third machine learning model 138. In various embodiments, the systems 132-138 may not be part of the provider computing system 105 but instead may be third-party machine learning models that are accessed by the provider computing system 105. As described herein, the systems 132-138 may be one or more circuits as the term “circuits” is defined herein.

The systems 134-138 may include, but are not limited to, large language models (LLMs), which are capable of processing complex input prompts and generating human-like responses and can be trained to generate human-like text, speech, images, or components of graphical user interfaces. The systems 134-138 may be structured using a deep learning architecture that includes a multitude of interconnected layers, including transformer layers, attention mechanisms, self-attention layers, and transformer blocks. The systems 134-138 are trained on large datasets to assimilate patterns, structures, and relationships within large corpuses of text data. According to one example embodiment, the first machine learning model 134 may be a NLP model and the second machine learning model 136 may be an LLM.

The systems 134-138 may be trained to generate outputs that closely resemble the characteristics of the input data. The systems 134-138 may be fine-tuned to generate specific output data, including data that is compatible with various database architectures or augmented reality systems. The systems 134-138 can be trained via optimization of a large number of parameters, in which the systems 132-138 learn to minimize the error between its predictions and the actual data points, resulting in highly accurate and coherent generative capabilities. For example, the systems 134-138 may be trained using human, agent-generated summaries that inform future-generated summaries by the systems 134-138.

Although various implementations describe the systems 134-138 as being large language models, it should be understood that the present techniques may be implemented in connection with any type of generative model. For example, the systems 134-138 may include large language models, multimodal generative models, stable diffusion models or other diffusion-based models, generative adversarial networks (GANs), variational autoencoder models, or any other type of generative model. In some implementations, such systems 134-138 may include additional output layers or may be otherwise configured to generate output values corresponding to the various scores described herein.

In some implementations, the systems 134-138 may include any number of input layers, hidden layers, and output layers. In some implementations, one or more systems 134-138 may be or include pre-trained generative models that are fine-tuned to specific applications. For example, the output of one or more of the systems 134-138 can be controlled and guided during a fine-tuning process by introducing task-specific loss functions or constraints, which can be utilized to optimize and specify particular application-specific outputs of the systems 134-138. In some implementations, one or more of the systems 134-138 may be trained using a fine-tuning process to automatically generate outputs corresponding to the one or more scores, which may be stored, for example, as part of score data or displayed via one or more graphical user interfaces (e.g., a graphical user interface of the user device 140).

Additionally, in various embodiments, the data analysis circuit 130 may be modality-agnostic and may implement classifier-driven detection of various signals. Further, the components of the data analysis circuit 13 may be implemented to analyze binary, multi-label, and/or multi-class classifiers. As such, the systems 134-138 may be implemented as classifier models with one or more first stages optimized for recall and one or more second stages optimized for precision. For example, the first machine learning model 134 may be optimized for recall and the second machine learning model 136 may be optimized for precision.

The retrieval circuit 132 may be configured to retrieve, receive, obtain, acquire, etc. a plurality of pieces of data. In some embodiments, the retrieval circuit 132 may retrieve communication sessions from the client application 145. For example, the retrieval circuit 132 may retrieve message data between two or more users of the client application 145. Specifically, the retrieval circuit 132 may receive or retrieve data regarding a plurality of communication sessions that occur across the network 101. As mentioned above and as an example, a communication session may include messages between a potential vacation home renter and a vacation home provider that are received by the retrieval circuit 132.

The retrieval circuit 132 may perform real-time monitoring of the client application 145 to cause the communication session data to be received or retrieved. For example, a trigger mechanism may be utilized or performed to cause the communication session to be transmitted to the retrieval circuit 132 or to cause the retrieval circuit 132 to retrieve the communication session. For example, the retrieval circuit 132 may monitor the client application and, upon detection of an initiation of a chat between two or more parties, the retrieval circuit 132 may begin retrieving data (e.g., messages) from the communication session in real time (e.g., as the messages are exchanged between parties, the retrieval circuit 132 also retrieves or receives the messages).

In some embodiments, communication sessions are transmitted to the provider computing system 105, for example, after the communication session has ended. The retrieval circuit 132 may receive or retrieve all data (e.g., messages) exchanged between the parties during the duration of the chat session from the provider computing system 105 rather than directly retrieving the messages from the client application 145. As such, the communication sessions may be stored in the memory 120 of the provider computing system 105. For example, the memory 120 may include a database within which communication session data is stored after retrieval of the communication session and/or additional data.

In some embodiments, the retrieval circuit 132 may initiate an application programming interface (API) call to the client application 145 including a request for communication session data. The client application 145 may read messages exchanged during communication session(s), including communication sessions occurring prior to the API call. The client application 145 may be configured to identify features of the communication sessions that may be relevant to the data analysis circuit 130 and transmit those communication sessions to the retrieval circuit 132 in response to the API call.

In some embodiments, the retrieval circuit 132 may retrieve additional data from the client application 145 and/or the provider computing system 105, such as a user’s browsing history, a user’s likes (e.g., saved travel routes, flights, vacation properties, etc.), a user’s dislikes, a context of a user’s history or preferences, payment information, log in information, reviews (e.g., property and/or experience reviews), property listing data, and the like.

The communication sessions, or parts thereof, may be in one or more formats. For example, the communication session, or parts thereof, may be formatted as textual communication sessions, image communication sessions, audio communication sessions, and/or video communication sessions. For example, the host property provider may provide images of certain parts of the host property (textual), include their voice description (voice), and include text regarding the host property. Thus, the retrieval circuit 132 may receive data regarding the communication session that is in one or more of a plurality of different formats.

In some embodiments, the retrieval circuit 132 may retrieve data from one or more third-party systems 170 associated with a plurality of third-party providers. The retrieval circuit 132 may retrieve the data from the plurality of sources by, for example, initiating a plurality of application programming interface (API) calls to the plurality of sources. For example, a communication session may occur between a user device 140 and a third-party system 170, between two third-party systems 170, etc., and such communication session information may be received by the retrieval circuit 132.

The first machine learning model 134 may be configured to receive the plurality of communication sessions from the retrieval circuit 132 and analyze each communication session. Specifically, in some embodiments, the first machine learning model 134 may be configured as a natural language processor (NLP). As such, the first machine learning model 134 may be configured to parse, analyze, and interpret complex, natural language patterns (e.g., human language). For example, the first machine learning model 134 may receive message data between two humans (e.g., a customer and a provider) and analyze the message data to understand the content of the message data, the context of the message data, and the like. In embodiments where the data analyzed by the first machine learning model 134 (and/or the second machine learning model 136) is non-textual data, such as audio or visual data, the first machine learning model 134 may be configured as a different type of machine learning model. For example, the first machine learning model 134 may perform a pixel analysis of image and/or video data. Similarly, the first machine learning model 134 may transcribe audio data and subsequently perform a textual analysis of the data.

Further, the first machine learning model 134 may be trained or tuned to identify at least one predefined characteristic (a flagging characteristic) of each of the communication sessions being analyzed. The characteristic(s) may indicate that the piece of data is relevant to a particular objective or use case of the data analysis performed by the data analysis circuit 130. As such, each characteristic may correspond to a predefined variable. The predefined variable may be a word or phrase indicating a particular attribute of the communication session. For example, the attribute of the communication session may be an indication of undesirable activity (e.g., fraud, policy violations, hate speech, offensive content, etc.). The characteristics may be, for example, specific words or phrases in textual data, patterns in the data, metadata associated with the data, a tone of the data, a structure of the content of the data, certain objects in image or video data, and the like. For example, a predefined variable may be a word or phrase indicating that the communication session includes offensive content. The identified characteristics may therefore include specific instances of profanity, harassment, hate speech, etc., in the communication session. As will be described in greater detail herein, the one or more characteristics may be general features of the data that may or may not be indicative of whether the piece of data is relevant to the particular objective of the data analysis circuit 130.

In some embodiments, the first machine learning model 134 may be configured to perform one or more actions responsive to identifying the one or more characteristics in the data. For example, the first machine learning model 134 may flag the communication session (e.g., data) being analyzed based on the identification of the at least one characteristic. A flag may be a marker or other indication that additional analysis of the communication session that includes the one or more characteristics is needed. The flagged communication sessions may be stored in the memory 120 of the provider computing system 105 (e.g., in a database).

As a first non-limiting example, the data analysis circuit 130 may be configured to analyze a communication session that includes message data to determine whether messages (e.g., between a two users) violate one or more policies of a platform of the system 105. As such, the first machine learning model 134 may be tuned or trained to identify characteristics that are or are indicative of certain language patterns, characteristics, or features of the message data that may be indicative of a policy violation.

As another non-limiting example, the data analysis circuit 130 may be configured to analyze message data to determine a sentiment of the message. The first machine learning model 134 may be trained to identify certain characteristics of the message data that indicate a sentiment of the message. For example, the data analysis circuit 130 may be configured to analyze message data from a communication session between a guest of a rental property and the host of the rental property. The data analysis circuit 130 may analyze messages between the parties to detect, for example, whether a message from a party includes a positive, negative, or neutral tone or content. For example, a guest may message a host using a positive tone. The data analysis circuit 130 may analyze the messages to detect that the message may include a positive sentiment (e.g., based on first identifying, by the first machine learning model 134, one or more words or phrases determined to correspond to a positive sentiment).

Responsive to the identification of a predefined characteristic in the communication session (e.g., data), the first machine learning model 134 may flag the communication session. Setting a flag may indicate that the data includes the characteristic that is indicative of the communication session being relevant to a particular objective or use case of the data analysis performed by the data analysis circuit 130. In other words, setting a flag may indicate that the identified characteristic corresponds to a predefined variable that indicates a particular attribute or feature of the communication session (e.g., that the session includes a policy violation, fraud, a particular sentiment, etc.). In one embodiment, the objective or attribute is unwanted activity. For example, flagging the communication session may indicate that the communication session includes at least one characteristic (e.g., word or phrase) indicative of an undesirable activity, such as a policy violation, fraudulence, a particular sentiment, and the like. Flagging the communication session may indicate that the communication session should be further analyzed by a second machine learning model 136.

In some embodiments, the first machine learning model 134 may utilize various processes depending on the format of the communication session, such as computer vision, speech-to-text models, and the like to analyze the communication sessions. For example, when the communication session is formatted as image, audio, or video data, natural language processing may not be able to analyze the data appropriately. Accordingly, the first machine learning model 134 may be implanted as a type of model that can accurately analyze the communication session. For example, the first machine learning model 134 may utilize computer vision to analyze image data. Similarly, the first machine learning model 134 may transcribe audio data into text and analyze the textual data. The first machine learning model 134 may further receive video data and analyze captions of the video, metadata of the video, etc., to identify one or more features of the video data.

The first machine learning model 134 may be configured to identify any aspect of the communication session as being a potential characteristic indicating that the communication session is relevant to the particular objective of the data analysis circuit 130. That is, the first machine learning model 134 may be configured to maximize the number of communication sessions that are determined to include the one or more characteristics by training or configuring the first machine learning model 134 to have a low threshold for determining that the data (e.g., communication session) includes at least one characteristic that indicates that the communication session is relevant to the objective of the data analysis circuit 130. As such, the one or more characteristics may be general aspects of the communication session, such as words or phrases, that may or may not actually be indicative of relevance of the data to the particular objective or may or may not indicate undesirable activity. That is, the first machine learning model 134 may identify any characteristic of the communication sessions that could potentially indicate relevance of the communication sessions to the objective as a characteristic of the data.

For example, the objective of the data analysis circuit 130 may be to identify, using message data, whether a vacation rental owner is encouraging a user to book the rental property without using the provider computing system 105, which is a policy violation of the provider. The first machine learning model 134 may identify at least one aspect of the data that could potentially be considered indicative of a policy violation as a characteristic. For example, the first machine learning model 134 may analyze the data and determine that the word “offline” appears in the message data. Though a single instance of this word may not definitively mean that the message does or does not include a policy violation, the first machine learning model 134 may identify the message data as including a first characteristic (e.g., the word “offline”) indicative of a potential policy violation.

Upon analyzing a communication session (e.g., a plurality of pieces of data, a plurality of messages between two parties, a plurality of transactions between two parties, a plurality of user preferences, etc.) and identifying a characteristic of the communication session, the first machine learning model 134 may flag each communication session that has been identified to include the characteristic. For example, the first machine learning model 134 may be configured to identify one or more characteristics of pieces of transaction data indicative of potential fraud. Each piece of data that has one or more identified characteristics that may indicate fraud is flagged. For example, the identified characteristic(s) of the transaction data may be transaction timestamps deemed suspicious, transaction recipients deemed suspicious, etc. Each piece of transaction data having these characteristics are flagged. The flagged communication sessions may undergo additional analysis. The unflagged communication sessions may be determined to not include the one or more characteristics, and may not undergo additional analysis because the first machine learning model 134 has determined that the unflagged communication session does not include at least one predefined characteristic that is indicative of relevance to the objective of the data analysis circuit 130 (e.g., the transaction data does not include any markers for fraud, etc.).

In some embodiments, the first machine learning model 134 may filter at least some data from each communication session that has been flagged. Specifically, the first machine learning model 134 may filter out one or more pieces of predefined sensitive data identified in the data or communication session. For example, the first machine learning model 134 may identify sensitive or otherwise personal or private information included in the communication session (e.g., a user’s name, usernames, passwords, personal identifiers, a user’s birthdate, financial account information, etc.). Sensitive information may alternatively or additionally include, for example, proprietary information, medical or health information, financial information, personal information such as religious beliefs, and the like. Filtering the data from the communication session may be performed by analyzing the content of the communication session to identify particular words or phrases. For example, the first machine learning model 134 may analyze the content of the communication session to identify one or more markers that indicate a piece of sensitive information. For example, the first machine learning model may identify a string of characters that are formatted as an email address (e.g., a string including “@” and “.com”), a string of characters that are formatted as a birth date (e.g., a strong formatted as DD-MM-YYYY), and the like. In some embodiments, the first machine learning model 134 identifies one or more words or phrases that indicate sensitive information such as the phrase “PIN number,” “password,” certain terms indicating personal beliefs such as “religion,” “political,’ and the like.

Upon identifying this sensitive information in the communication session, the first machine learning model 134 may filter out the data including the sensitive information. Filtering out the sensitive information may include, for example, redacting the sensitive information, scrubbing the communication to remove the sensitive information, removing the sensitive information, replacing the sensitive information with placeholder or anonymized data, and the like. For example, sensitive information may be removed, masked to be represented by different characters (e.g., replacing a phone number with asterisks), substituting sensitive information (e.g., replacing a user’s name with a false name such as John Doe), encrypting the sensitive information, etc.

The first machine learning model 134 may filter the sensitive information from the data prior to transmitting the data to the second machine learning model 136 for additional analysis. In some embodiments, the first machine learning model 134 transmits uncleaned or unfiltered data to the second machine learning model 136 and the second machine learning model 136 filters or cleans each of the pieces of data prior to analysis.

The second machine learning model may be configured as an LLM as described above. The second machine learning model 136 may receive each piece of data or communication session that has been flagged by the first machine learning model 134 (e.g., the pieces of data determined to include one or more characteristics indicating that the piece of data is relevant to the objective of the data analysis circuit 130).

The second machine learning model 136 may analyze each piece of flagged data to determine an intent of the communication session. For example, the second machine learning model 136 may analyze the communication session to identify one or more features that indicate that an intent of the communication session is relevant to the objective of the data analysis circuit 130 or satisfies a predefined attribute (e.g., undesirable activity). For example, the second machine learning model 136 may determine a predefined attribute associated with the data. The predefined attribute may be or include the relevancy of the data to the objective of the data analysis circuit 130. For example, the predefined attribute may be whether data indicates a policy violation, a particular sentiment of data, fraudulence in data, etc.

In various embodiments, the second machine learning model 136 may reanalyze the characteristic(s) identified by the first machine learning model 134. The second machine learning model 136 may be configured to more precisely identify features of the communication session that indicate whether the communication session is relevant to the objective or satisfies the predefined attribute. For example, as described above, the first machine learning model 134 may be configured to identify any characteristics of the communication session that may indicate that the communication session is relevant to the objective or indicates undesirable activity. The second machine learning model 136 may be configured to refine the results of the analysis from the first machine learning model 134. Accordingly, the second machine learning model 136 improves the precision associated with determining whether the communication session is relevant to the objective.

For example, the first machine learning model 134 may identify one or more characteristics of the communication session that the first machine learning model 134 determines indicates that the communication session is relevant to the objective of the data analysis circuit 130, and the communication session may then be transmitted to the second machine learning model 136 for further analysis. The second machine learning model 136 may be tuned to analyze the communication session to identify subtleties in the communication session that the first machine learning model 134 is unable to detect. As such, the second machine learning model 136 may identify one or more features not identified by the first machine learning model 134 that actually indicate that the communication session is not relevant to the objective of the data analysis circuit 130. The second machine learning model 136 may determine whether these features satisfy a predefined attribute to determine whether the communication session is or is not relevant to the objective of the data analysis circuit 130

For example, the objective of the data analysis circuit 130 may be to determine a fraudulent payment, and, as such, the predefined attribute may be a state of fraudulence of the payment. The first machine learning model 134 may analyze a communication session that may include transaction data. The transaction data may be analyzed by the first machine learning model 134, which may determine that a transaction occurred in a location that is not typical for a user associated with the data (e.g., the transaction occurred in a different country that the user’s home address). The first machine learning model 134 may therefore identify a characteristic (e.g., the transaction location) of the transaction data that indicates that the transaction is fraudulent, and flag that piece of transaction data. The second machine learning model 136 may then reanalyze the communication session. The second machine learning model 136 may determine an intent of the transaction data that indicates that the transaction was not actually fraudulent. For example, the second machine learning model 136 may be trained or tuned to identify a context of the transaction. As such, the second machine learning model 136 may identify a context of the transaction that indicates that the user associated with the transaction was on vacation in the country in which the transaction occurred. The second machine learning model 136 may then determine whether the identified context satisfies the predefined attribute of the fraudulence of the communication session. The identified context may be determined to not satisfy the predefined attribute because the context indicates that the transaction was not fraudulent. Accordingly, the second machine learning model 136 may determine that the communication session is not actually relevant to the objective (e.g., the communication session is not actually indicative of fraud).

Responsive to a determination that the determined intent of a piece of data or communication session does not satisfy the predefined attribute, the flag placed on the data or the communication session more broadly by the first machine learning model 134 may be removed. For example, because the second machine learning model 136 has determined that the data does not include or indicate the predefined attribute (e.g., the data is not relevant to an objective of the data analysis circuit 130), no further action may be taken on the communication session. When the flag is removed from the data/communication session, the flag or marker, and therefore the communication session, may be removed from the database (e.g., the database stored in the memory 120 that includes flagged communication sessions).

As another example, the objective of the data analysis circuit 130 may be to determine that a rental property owner is messaging a potential renter in a manner that violates the policies of the platform on which the rental property is listed. Accordingly, the predefined attribute may be that the data indicates a policy violation. The first machine learning model 134 may identify a characteristic that the rental property owner sent a potential renter their phone number in an obfuscated manner (e.g., the owner sent multiple messages, each containing a portion of the phone number, rather than sending the number in a single message), and flag the data (e.g., messages). The data may then be transmitted to the second machine learning model 136 for additional analysis. The second machine learning model 136 may identify an intent of the data, such as by analyzing or identifying context of the messages being sent. For example, the second machine learning model 136 may analyze additional messages between the owner and the potential renter which indicate that the owner was requesting that the renter book the rental property without using the platform on which the property was listed (e.g., a policy violation of the platform). The context or intent identified by the second machine learning model 136 confirms the determination made by the first machine learning model 134. As such, the second machine learning model 136 determines that the intent of the data satisfies the predefined attribute of the data indicating a policy violation. The data analysis circuit 130 therefore confirms that the piece of data is relevant to the objective of the data analysis circuit 130 (e.g., the message data does include an instance of a policy violation).

As alluded to above, the second machine learning model 136 may be configured to determine whether the first machine learning model 134 has falsely identified a communication session as including characteristics indicating relevancy of the data to the objective of the data analysis circuit 130. The determination, by the second machine learning model 136, of false positive identifications by the first machine learning model 134 can be performed by analyzing a context or intent of the one or more characteristics and/or other aspects of the piece of data. The second machine learning model 136 may perform a more detailed, and therefore more computationally intensive, analysis of the data relative to the analysis performed by the first machine learning model 134.

As described above, responsive to determining an intent of data or a communication session, the second machine learning model 136 may determine whether the determined intent of the satisfies a predefined attribute of the data or communication session. Based on the intent not satisfying the predefined attribute, the second machine learning model 136 may remove the flag on the data or communication session that was set by the first machine learning model 134. The flag may be removed because the analysis by the second machine learning model 136 has indicated that no further actions should be taken for the piece of data.

Based on the intent satisfying the predefined attribute, the second machine learning model 136 may initiate one or more actions. The one or more actions may be associated with or based on the objective of the data analysis circuit 130. For example, in some embodiments, the objective of the data analysis circuit 130 may determine whether data analyzed by the machine learning models is indicative of fraudulent activity. The initiated action may therefore be determining that the analyzed communication session is or is not indicative of fraudulent activity. Similarly, the objective of the data analysis circuit 130 may be to determine whether a communication session violates a policy, or determine a sentiment of a communication session. The initiated action may be to generate or output a determination of whether the communication session violates the policy, or generate an output indicating the sentiment of the communication session, respectively.

In some embodiments, the second machine learning model 136 (and/or another component of the data analysis circuit 130) may format the communication session, store the communication session, transmit the communication session, etc. Specifically, the communication session may be stored when used for training purposes. The processes performed by the first and second machine learning models may be used as training data. For example, a communication session may be used to train the first machine learning model 134 to identify one or more characteristics of the communication session and/or used to train the second machine learning model 136 to determine whether an intent of the communication session satisfies a predefined attribute.

The communication session and the output of the initiated action may also be transmitted to one or more parties. Specifically, the data and the output may be transmitted to a user associated with the communication session. For example, the data analysis circuit 130 may determine that a rental property owner has violated one or more policies of an entity (e.g., a provider through which the rental property is listed for rental). The second machine learning model 136 may transmit the indication that the owner has violated the policy and the communication session to the rental property owner.

In some embodiments, the initiated action may include taking one or more actions for or against a user. For example, responsive to a determination that a communication session has violated one or more policies, the communication session between the users may be disconnected or terminated so no further messages may be sent. Further, one or more of the users included in the communication session may be removed from the platform on which the communication session occurred. The removal may be temporary or permanent.

While the description of the components of FIG. 2 have been described with respect to analyzing communication sessions and identifying characteristics and intent of such communication sessions, it should be understood that the components and processes of the data analysis circuit 130 may alternatively or additionally be applied to recommender systems. For example, the data analysis circuit 130 may analyze network activity that includes user activity on, for example, the client application 145.

For example, the data analysis circuit 130 may analyze user data, such as user preferences, user behavior, user history (e.g., browsing data on the client application 145, etc.), user metadata, etc., and a context of the user data. The data analysis circuit 130 may analyze the data to then initiate an action that includes generating one or more recommendations for a user. For example, the recommendation may be a travel recommendation, a product recommendation, a media recommendation (e.g., a movie, show, music, or other type of media recommendation).

Accordingly, the retrieval circuit 132 may receive or retrieve user data. The first machine learning model 134 may analyze the received user data and identify one or more characteristics of the user data. The first machine learning model 134 may then generate a general recommendation using the identified one or more characteristics. The characteristics may be features of the user data that may indicate preferences relevant to the particular recommendation being generated. For example, the data analysis circuit 130 may be configured to generate a travel recommendation for a user. The first machine learning model 134 may be trained to identify certain characteristics in user data that indicates a user preference regarding travel, such as lodging preferences, destination preferences, and the like. The user preferences may be used to generate a first, general recommendation for a user. The recommendation may include, for example, an origin and destination and dates of travel. The recommendation generated by the first machine learning model 134 may be general relative to a fine-tuned recommendation generated by a second machine learning model 136.

The second machine learning model 136 may receive the user data and first generated recommendation. The second machine learning model 136 may fine-tune the first generated recommendation to generate a second recommendation that includes more detail or information relevant to the user relative to the first recommendation. For example, the first machine learning model 134 may generate a recommendation that includes dates of travel and an origin and destination. The second machine learning model 136 may more closely analyze the user data (relative to analysis by the first machine learning model 134) and the first recommendation. Thus, the recommendation generated by the second machine learning model 136 may include specific flights for the user, accommodations, and activities that the second machine learning model 136 has predicted will match the user’s preferences.

As another example, the objective of the data analysis circuit 130 may be to generate a recommendation of a film for a user to view. The first machine learning model 134 may analyze user data to identify one or more characteristics relevant to generating a recommendation (e.g., data regarding a user’s film watching experience or habits). For example, the first machine learning model 134 may analyze the user’s previously watched films, locations at which the user views films, platforms on which the user views films, etc., to generate a recommendation. The recommendation may be general recommendation that does not include a high level of detail. For example, the recommendation may include a recommendation that the user watch a particular genre of film. The second machine learning model 136 may further analyze the data to fine tune the recommendation generated by the first machine learning model 134. The second machine learning model 136 may identify features (e.g., a context or intent) of the data that indicate more detailed or precise information about the user’s preferences. For example, the characteristics identified by the first machine learning model 134 may be films the user has previously viewed and the features identified by the second machine learning model 136 may be particular actors or actresses commonly featured in the films the user has viewed. The second machine learning model 136 may then generate a more detailed recommendation that includes the users particular preferences. For example, the second machine learning model 136 may generate a recommendation that the user watch a specific film of the genre included in the recommendation generated by the first machine learning model 134 that includes a particular actor the second machine learning model 136 has determined the user likes.

In embodiments in which the multi-stage machine learning architecture is used to generate recommendations, as described above, the initiated one or more actions may include generating a final recommendation and transmitting the recommendation to the user. For example, the objective of the data analysis circuit 130 may be to generate a recommendation. The initiated action may be to output the final recommendation generated by the second machine learning model 136 and transmit the recommendation to the user.

The data analysis circuit 130 may optionally include a third machine learning model 138. The third machine learning model 138 may be a LLM as described herein. The third machine learning model 138 may be configured to generate a description or reason describing why the first and second machine learning models have identified aspects of the communication session indicating that the communication session is relevant to the objective of the data analysis circuit 130 and/or why the intent determined by the second machine learning model 136 has satisfied the predefined attribute. In some embodiments, this description may be generated by the second machine learning model 136.

For example, the third machine learning model 138 may receive, from the second machine learning model 136, the communication session and an indication that the communication session satisfies the predefined attribute. The third machine learning model 138 may be provided a prompt instructing the third machine learning model 138 to generate a textual (e.g., natural language) description of why communication session satisfies the predefined attribute (e.g., why the communication session is relevant to the objective of the data analysis circuit 130, why the intent indicates certain undesirable activity, etc.). For example, the predefined attribute may be that a message between a rental property owner and a potential customer includes a policy violation. Specifically, an objective of the data analysis circuit 130 may be to identify whether a message between a rental property owner and a potential customer includes a policy violation that the rental property owner has attempted to have the potential customer book the rental property without using the listing platform. The third machine learning model 138 may receive a prompt stating, for example: “Using the data provided, generate a written description explaining why the message data includes a policy violation.” The prompt may be received from the second machine learning model 136 or a user of the provider computing system 105 that may review outputs of the second machine learning model 136.

The prompts may, in some embodiments, be pre-generated and correspond to the particular predefined attribute being satisfied. For example, the second machine learning model 136 may determine that an intent of the communication session satisfies a predefined attribute, where the predefined attribute is the communication session including a policy violation. The second machine learning model 136 may have an associated generic, pre-generated prompt that is transmitted to the third machine learning model 138 any time the communication session intent satisfies a policy violation attribute. In this manner, a machine learning model may not be used to generate the prompt. Rather, the pre-generated prompt may be automatically provided.

In various embodiments, the explanations provided by the third machine learning model 138 may be pre-generated or pre-stored explanations. Pre-generated explanations may correspond to each of the predefined attributes. For example, the second machine learning model 136 may determine that the intent of the communication session satisfies the predefined attribute of the communication session including a policy violation. The third machine learning model 138 may receive an indication that the predefined attribute is related to a policy violation and transmit an explanation. The pre-generated explanation may be generic. For example, the explanation may state: “At least one of the messages sent in this chat session has been determined to violate a policy of this provider.” In this manner, the third machine learning model 138 may not utilize machine learning techniques, but instead transmits a pre-generated explanation to a relevant recipient (e.g., a user involved in the communication session).

The output of the third machine learning model 138 may, in some embodiments, use the identified characteristics and intent of the communication session or data as evidence or support for why the predefined attribute has been satisfied. Using the example above, the output of the third machine learning model 138 may be, for example: “A message between a rental property host and a customer was flagged because the host attempted to share a phone number using an obfuscated format (e.g., splitting the number into separate phrases across the message). This behavior violates the booking platform’s policy against sharing contact information during pre-booking communication.” As shown in the example, the characteristic identified by the first machine learning model 134 may be the messaging of the cell phone number. The intent identified by the second machine learning model 136 may be the request that the customer text the property owner to book the property. Therefore, as shown in the example above, the generated description may include the characteristics and intent identified by the machine learning models. The generated description may also include additional information gathered by the first and/or second machine learning models during analysis of the data.

The communication session may be analyzed along with the prompt provided to the third machine learning model 138 to generate an output that identifies the particular aspects of the communication session that caused the first machine learning model 134 to flag the communication session. For example, the third machine learning model 138 may analyze the communication session and, specifically, the identified characteristics, within the context of the prompt provided to the third machine learning model 138, to generate an explanation of why the intent of the communication session satisfies the predefined attribute.

In some embodiments, the generated description is transmitted, along with the communication session and the identified characteristics, to one or more parties. For example, the communication session and description may be transmitted to a person for whom a recommendation is generated, a person that has committed fraud or policy violations, a person associated with an account that has experienced fraudulent activity, etc. In some embodiments, the data is transmitted to the provider computing system 105. The provider computing system 105 may use the information to take further actions regarding the communication session. For example, the provider computing system 105 may ban a host that has violated the policy (e.g., more than a certain number of times, etc.).

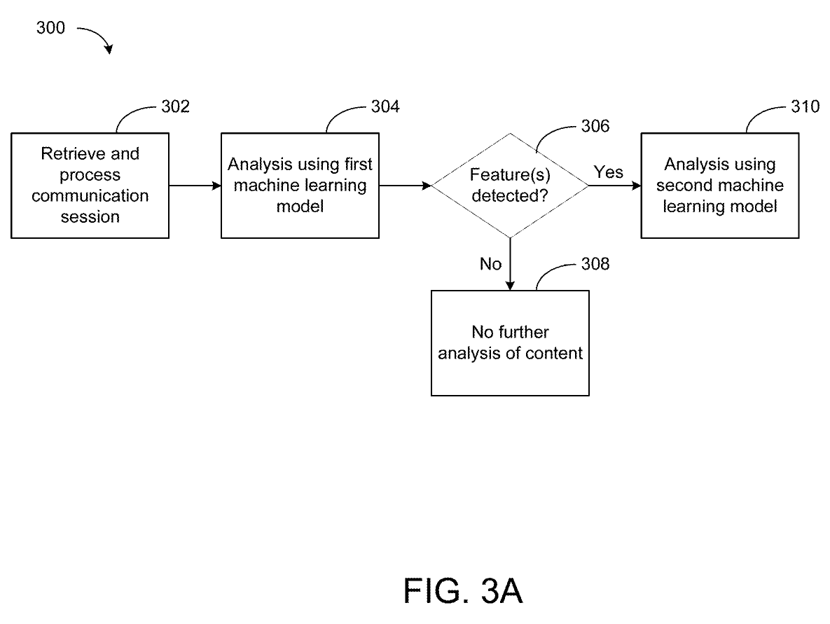

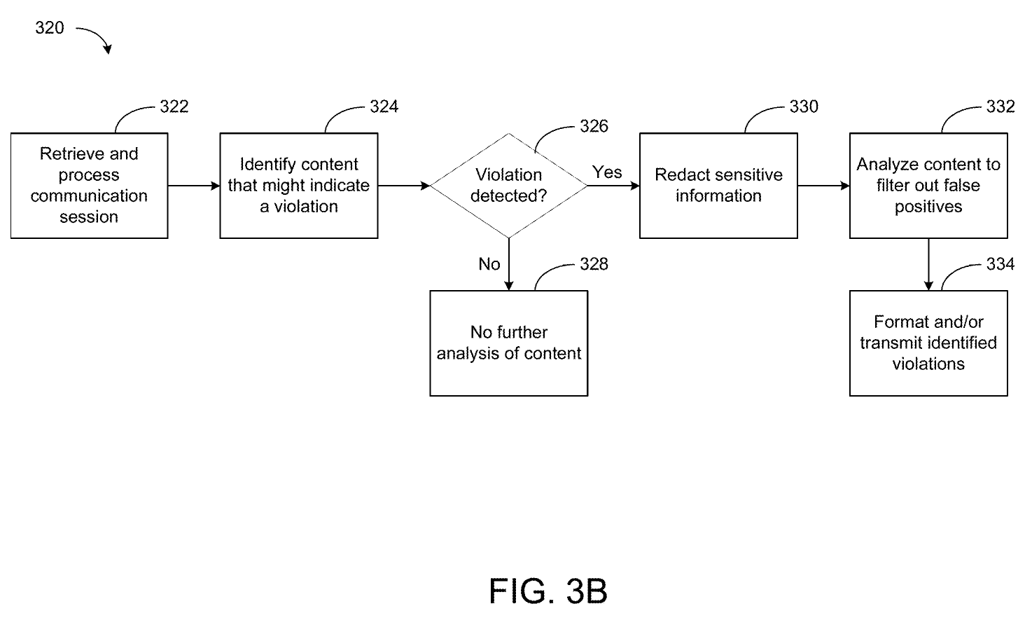

Referring now to FIG. 3A, a method 300 for analyzing communication sessions using a two stage process is shown, according to an example embodiment. The method 300 may be performed by the components of the data analysis circuit 130. In some embodiments, the processes depicted may be performed in another order, certain processes may be omitted, and/or certain additional processes added without departing from the scope of the disclosure.

At process 302, a communication session is retrieved and processed. Specifically, the retrieval circuit 132 may retrieve one or more communication sessions from one or more sources (e.g., from a client application 145, from a third-party system 170, from the provider computing system 105, etc.). The retrieval circuit 132 may process the communication session so that the communication session is formatted such that machine learning models are capable of analyzing the communication session.

At process 304, the first machine learning model 134 analyzes the communication session. Specifically, the first machine learning model 134 analyzes the communication session to identify one or more characteristics of the communication session. In some embodiments, the analysis by the first machine learning model 134 may include generating one or more predictions regarding whether the data is relevant to the objective of the data analysis circuit 130.

At process 306, whether the first machine learning model 134 has identified characteristics within the communication session that indicate that the communication session is relevant to the objective of the data analysis circuit 130 is determined. Responsive to a determination that the communication session does not include such characteristics, at process 308, analysis of the content may cease. For example, because the first machine learning model 134 has identified that a communication session does not include the characteristics, the first machine learning model 134 may determine that the communication session is not relevant to the objective of the data analysis circuit 130.

Responsive to a determination at process 306 that the communication session does include one or more characteristics or features indicating that the communication session is relevant to the objective, at process 310, the second machine learning model 136 analyzes the communication session (e.g., as a result of the first machine learning model flagging the communication session). The second machine learning model 136 may analyze the communication session to identify one or more features, such as a context or an intent, of the communication session that indicate that the communication session is relevant to the objective. In some embodiments, the characteristics of the communication session identified at process 306 may be content of the communication session, and the features identified at process 310 may be an intent or context of the content of the data.

Referring now to FIG. 3B, a method 320 for analyzing communication sessions using a multi-, particularly a two stage, process is shown, according to an example embodiment. The method 320 may be performed by the components of the data analysis circuit 130. The method 320 may illustrate a specific example or use of the method 300. Specifically, the method 320 illustrates a method of determining whether messages between a rental property host and a potential customer include a violation of a policy of the platform on which the rental property is listed. For example, the policy violation may be that the rental property host has attempted to have the potential customer book the rental property without using the listing platform.

At process 322, a communication session is retrieved and processed. Specifically, the retrieval circuit 132 may retrieve messaging data between a rental property host and a potential customer from the provider computing system 105 and/or the client application 145. The retrieval circuit 132 may process the communication session so that the communication session is formatted such that machine learning models are capable of analyzing the communication session.

At process 324, the first machine learning model 134 identifies content within the messaging data that potentially indicates a policy violation. For example, the first machine learning model 134 may identify that the message data includes a phone number shared by the host (e.g., in an obfuscated manner, such as by sending portions of the phone number in separate messages).

At process 326, the first machine learning model 134 determines whether a violation has been detected. The first machine learning model 134 may determine that a violation has been detected when one or more characteristics (e.g., particular words or phrases) as described above are detected.

Responsive to a determination that the communication session does not include the one or more characteristics, at process 328, analysis of the communication session (e.g., messaging data) may cease. For example, because the first machine learning model 134 has identified the messaging data does not include potential markers of a policy violation, such as sharing of contact information, the first machine learning model 134 may determine that the messaging data is not relevant to the objective of the data analysis circuit 130.

Responsive to a determination at process 326 that the communication session does include characteristics indicating that the messaging data is relevant to determining that the data includes a policy violation, at process 330, the first machine learning model 134 filters sensitive information from the data. For example, the first machine learning model 134 may redact private information including user names, phone numbers, passwords, etc. The filtered data may then be transmitted to the second machine learning model 136. At process 332, the second machine learning model 136 analyzes the filtered messaging data and/or identified characteristics to identify and filter out false positives identified by the first machine learning model 134. For example, the first machine learning model 134 may identify characteristics or features that the first machine learning model 134 has been trained to flag as indicating that the data is relevant to the objective of the data analysis circuit 130. However, the second machine learning model 136 may more precisely analyze the data and determine that the identified characteristics are or are not actually indicative of the data being relevant to the objective, and the first machine learning model 134 mistakenly identified the characteristics as being indicative. For example, the second machine learning model 136 may identify features that indicate a context or intent of the messages (e.g., the communication session). For example, the second machine learning model 136 may determine a context of why the host shared their phone number with the potential customer. Depending on this context, the second machine learning model 136 may determine that the identification by the first machine learning model 134 was or was not a false positive identification.

At process 334, responsive to a determination by the second machine learning model 136 that the analysis by the first machine learning model 134 did not generate a false positive result (e.g., the second machine learning model 136 identified features that confirmed the result of the first machine learning model analysis), the identified policy violation may be formatted and/or transmitted. For example, the message data, the characteristics, and/or the intent may be formatted to be stored in a table. The formatted data may be transmitted to, for example, the rental property host that performed the violation. In some embodiments, the data is transmitted to the provider of the booking platform.

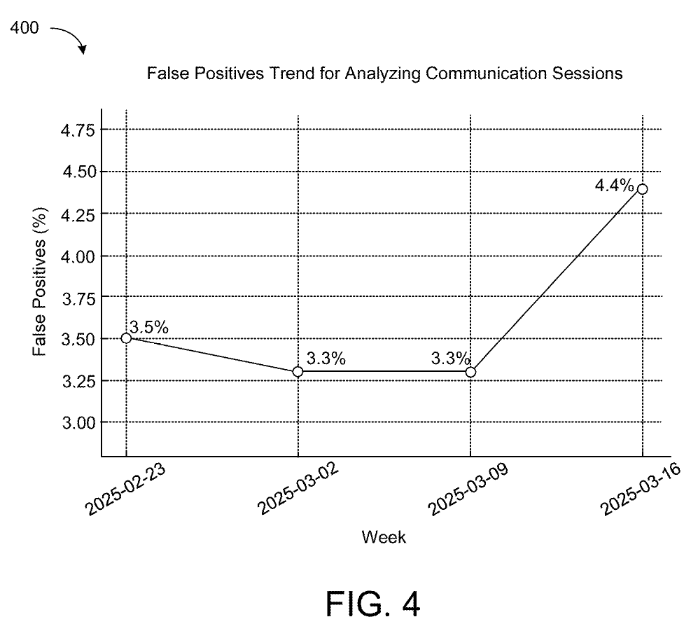

Referring now to FIG. 4, a graph 400 showing a rate of false positives within communication sessions analyzed by the data analysis circuit 130 is shown, according to an example embodiment. As shown in the graph 400, a rate of false positive identification using the data analysis circuit 130 may be, in some embodiments, less than 5%. For example, less than 5% of data analyzed by the first machine learning model and subsequently by the second machine learning model was determined to be incorrectly flagged by the first machine learning model 134 as including characteristics. In various examples, the rate of false positives may be greater than 5% without the use of a two-stage machine learning data analysis circuit 130.

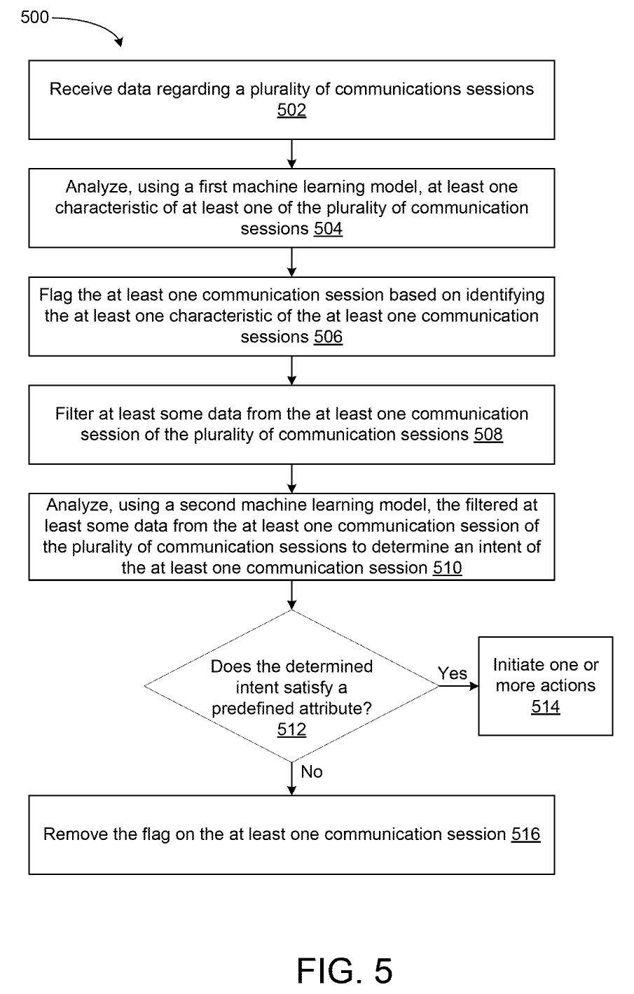

Referring now to FIG. 5, a flowchart of a method 500 for data analysis using a multi-stage, namely a two stage, machine learning model process is shown, according to an example embodiment. The method 500 may be performed by one or more components of the system 100. In particular, various operations may be performed by the provider computing system 105, such as the data analysis circuit 130. Operations may also be performed by the user device 140 and/or third-party system 170. It should be understood that the order of operations may differ from what is depicted and operations may be added, deleted, or combined without departing from the scope of the method 500.

At process 502, data regarding a plurality of communications sessions is received. For example, the data may be received by the retrieval circuit 132.

At process 504, at least one characteristic of at least one of the plurality of communication sessions is analyzed. The at least one characteristic may be analyzed by the first machine learning model 134. In some embodiments, the at least one communication session is a textual communication session. For example, the at least one communication session may be a chat session between an owner of a vacation rental property and a potential renter of the vacation rental property. In other examples, the communication session may be a transaction between two parties, a request from a user for a recommendation (e.g., a travel recommendation, a product recommendation, a media recommendation, etc.), a review of a product or property, etc. In some embodiments, the communication session may be or include communication in the form of photos, videos, audio, and/or other media formats.

In some embodiments, the at least one characteristic corresponds to a predefined variable. The predefined variable may a word or phrase indicative of a particular feature or predefined attribute of the communication session. For example, the predefined variable may be a word or phrase that indicates whether the communication session is indicative of an off-platform booking violation or another policy violation by a party (e.g., a vacation property owner). The at least one characteristic may be a particular word or phrase in message data indicating such a variable, such as a phone number sent across one or more messages, the phrase “book offline,” etc. In another embodiment, the predefined variable may be a word or phrase indicating a sentiment of a communication (e.g., message), and the characteristic may be one or more words or phrases in the communication that may indicate sentiment, such as “like,” “dislike,” “enjoy,” “unpleasant,” etc. In still another embodiment, the predefined variable may be a word or phrase indicating be whether the communication is indicative of fraud, and the characteristic may be an indicator of fraud. As such, the characteristic may be “off the books,” “provide credit card information,” etc.

At process 506, the first machine learning model 134 may flag the at least one communication session based on identifying the at least one characteristic of the at least one communication session. In some embodiments, the first machine learning model 134 is a natural language processing (NLP) model. The flag set at process 506 may indicate that the communication session includes characteristics that may indicate that the communication session is of a particular type or includes one or more attributes. For example, the flag may indicate that the communication session includes characteristics that may indicate that the communication session violates a policy, is fraudulent, has a particular sentiment, etc.

At process 508, at least some of the data from the at least one communication session is filtered. The first machine learning model 134 or the second machine learning model 136 may filter the data. In some embodiments, data that is filtered out from the at least one communication session may be at least some predefined sensitive data identified in the at least one communication session. For example, the communication session may be a chat between two parties, and the predefined sensitive data may be or include personal identification data of one or both of the parties, such as a full name, address, email, phone number, account numbers, passwords, etc. As such, process 508 may include redacting and/or cleaning data from the at least one communication session.

At process 510, the filtered at least some data is analyzed. The filtered at least some data may be analyzed by the second machine learning model 136. In some embodiments, the second machine learning model 136 is a large language model. As such, in some embodiments, the first machine learning model is different than the second machine learning model (e.g., the first machine learning model is an NLP model and the second machine learning model is an LLM). The filtered at least some data may be analyzed to determine an intent of the at least one communication session. For example, the second machine learning model may analyze one or more aspects of the communication session and determine an intent of the aspect. For example, the second machine learning model may analyze messages between a property owner and a potential renter that the first machine learning model flagged as including a characteristic indicative of the messages violating a policy. The second machine learning model may analyze the messages to identify an intent of the content of the messages and determine if the intent were to violate the policy.

At process 512, the second machine learning model 136 determines whether the determined intent satisfies a predefined attribute. The predefined attribute may be associated with the predefined variable or the at least one characteristic. For example, the predefined attribute may be: a condition that the analyzed data is or is not indicative of a platform policy violation, a particular sentiment of the data, a condition that the analyzed data is or is not indicative of fraud, etc.

At process 514, responsive to the second machine learning model 136 determining, at process 512, that the determined intent does satisfy the predefined attribute, the second machine learning model 136 initiates one or more actions. Initiating the one or more actions includes generating, using a third machine learning model, an explanation regarding the determined intent satisfying the predefined attribute. For example, the second machine learning model may analyze an intent of a message from a vacation rental owner to a prospective renter. The intent of the message may be determined to be that the owner wanted to have the renter book the property without using the platform on which the property was listed. The predefined attribute may be that the messages are indicative of fraud. As such, the second machine learning model may determine that the intent of the messages satisfies the predefined attribute of being indicative of a policy violation. One or more actions may be initiated. The action may therefore be, for example, generating a natural language explanation of why the messages have been determined to be indicative of a policy violation. Process 514 may further include sending the generated explanation to at least one user device associated with the at least one communication session.

In some embodiments, the third machine learning model is the same as the second machine learning mode. For example, the second machine learning model may initiate the one or more actions. In other embodiments, the third machine learning model may be different than the second machine learning model but may be of the same type as the second machine learning model. For example, the third machine learning model may be a large language model.

At process 516, responsive to the second machine learning model 136 determining, at process 512, that the determined intent does not satisfy the predefined attribute, the second machine learning model 136 removes the flag on the at least one communication session. For example, the second machine learning model may analyze message data between a rental property owner and a prospective customer and determine that an intent of the owner’s message was not to perform a policy violation. As such, the intent of the communication session may not satisfy a predefined attribute of being indicative of a policy violation.

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

The implementations described herein have been described with reference to drawings. The drawings illustrate certain details of specific implementations that implement the systems, methods, and programs described herein. Describing the implementations with drawings should not be construed as imposing on the disclosure any limitations that may be present in the drawings.

It should be understood that no claim element herein is to be construed under the provisions of 35 U.S.C. § 112(f) unless the element is expressly recited using the phrase “means for.”

As used herein, the term “circuit” may include hardware structured to execute the functions described herein. In some implementations, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some implementations, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. In a non-limiting example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some implementations, the one or more processors may be embodied in various ways. The one or more processors may be constructed in a manner sufficient to perform at least the operations described herein. In some implementations, the one or more processors may be shared by multiple circuits (e.g., circuit A and circuit B may comprise or otherwise share the same processor, which, in some example implementations, may execute instructions stored, or otherwise accessed, via different areas of memory). Alternatively or additionally, the one or more processors may be structured to perform or otherwise execute certain operations independent of one or more co-processors.

In other example implementations, two or more processors may be coupled via a bus to enable independent, parallel, pipelined, or multi-threaded instruction execution. Each processor may be implemented as one or more processors, ASICs, FPGAs, GPUs, TPUs, digital signal processors (DSPs), or other suitable electronic data processing components structured to execute instructions provided by memory. The one or more processors may take the form of a single core processor, multi-core processor (e.g., a dual core processor, triple core processor, or quad core processor), microprocessor, etc. In some implementations, the one or more processors may be external to the apparatus, in a non-limiting example, the one or more processors may be a remote processor (e.g., a cloud-based processor). Alternatively or additionally, the one or more processors may be internal or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the implementations might include general-purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile or non-volatile memories), etc. In some implementations, the non-volatile media may take the form of ROM, flash memory (e.g., flash memory such as NAND, 3D NAND, NOR, 3D NOR), EEPROM, MRAM, magnetic storage, hard disks, optical disks, etc. In other implementations, the volatile storage media may take the form of RAM, TRAM, ZRAM, etc. Combinations of the above are also included within the scope of machine-readable media. In this regard, machine-executable instructions comprise, in a non-limiting example, instructions and data, which cause a general-purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example implementations described herein.

It should also be noted that the term “input devices,” as described herein, may include any type of input device including, but not limited to, a keyboard, a keypad, a mouse, joystick, or other input devices performing a similar function. Comparatively, the term “output device,” as described herein, may include any type of output device including, but not limited to, a computer monitor, printer, facsimile machine, or other output devices performing a similar function.

It should be noted that although the diagrams herein may show a specific order and composition of method steps, it is understood that the order of these steps may differ from what is depicted. In a non-limiting example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative implementations. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps, and decision steps.

While this specification contains many specific implementation details, these should not be construed as limitations on the scope of any arrangements or of what may be claimed, but rather as descriptions of features specific to particular implementations of the systems and methods described herein. Certain features that are described in this specification in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

In particular, although many of the examples presented herein involve specific combinations of method acts or system elements, those acts and those elements may be combined in other ways to accomplish the same objectives. Acts, elements, and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act, or element may include implementations where the act or element is based at least in part on any information, act, or element.

Any implementation disclosed herein may be combined with any other implementation, and references to “an implementation,” “some implementations,” “an alternate implementation,” “various implementations,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The foregoing description of implementations has been presented for purposes of illustration and description. It is not intended to be exhaustive or to limit the disclosure to the precise form disclosed, and modifications and variations are possible in light of the above teachings or may be acquired from this disclosure. The implementations were chosen and described in order to explain the principals of the disclosure and its practical application to enable one skilled in the art to utilize the various implementations and with various modifications as are suited to the particular use contemplated. Other substitutions, modifications, changes, and omissions may be made in the design, operating conditions, and implementation of the implementations without departing from the scope of the present disclosure as expressed in the appended claims.

What is claimed is:

1. A system for monitoring network activity, the system comprising:
one or more non-transitory computer readable media storing instructions thereon that, when executed by one or more processors, cause the one or more processors to:
receive data regarding a plurality of communications sessions;
analyze, using a first machine learning model, the data to identify at least one characteristic of at least one of the plurality of communication sessions;
flag the at least one communication session based on identifying the at least one characteristic of the at least one communication session;
filter at least some data from the at least one communication session of the plurality of communication sessions;
subsequent to filtering the at least some data from the at least one communication session, analyze, using a second machine learning model, the filtered at least some data from the at least one communication session of the plurality of communication sessions to determine an intent of the at least one communication session;
responsive to the determined intent of the at least one communication session satisfying a predefined attribute, initiate one or more actions; and
responsive to the determined intent of the at least one communication session not satisfying the predefined attribute, remove the flag on the at least one communication session.

2. The system of claim 1, wherein the at least one characteristic corresponds to a predefined variable, and wherein the predefined variable is at least one of a word or a phrase.

3. The system of claim 1, wherein the first machine learning model is a natural language processing (NLP) model.

4. The system of claim 1, wherein the at least one communication session is a textual communication session.

5. The system of claim 1, wherein the filtering is of at least some predefined sensitive data identified in the at least one communication session.

6. The system of claim 1, wherein the second machine learning model is a large language model (LLM).

7. The system of claim 1, wherein the first machine learning model is different than the second machine learning model.

8. The system of claim 1, wherein initiating the one or more actions comprises:
generating, using a third machine learning model, an explanation regarding the determined intent satisfying the predefined attribute; and
sending the generated explanation to at least one user device associated with the at least one communication session.

9. The system of claim 8, wherein the third machine learning model is the same as the second machine learning model.

10. The system of claim 8, wherein the third machine learning model is a large language model.

11. A method for monitoring network activity, the method comprising:
receiving, by one or more processors, data regarding a plurality of communications sessions;
analyzing, by the one or more processors and using a first machine learning model, the data to identify at least one characteristic of at least one of the plurality of communication sessions;
flagging, by the one or more processors, the at least one communication session based on identifying the at least one characteristic of the at least one communication session;
filtering, by the one or more processors, at least some data from the at least one communication session of the plurality of communication sessions;
subsequent to filtering the at least some data from the at least one communication session, analyzing, by the one or more processors and using a second machine learning model, the filtered at least some data from the at least one communication session of the plurality of communication sessions to determine an intent of the at least one communication session;
responsive to the determined intent of the at least one communication session satisfying a predefined attribute, initiating, by the one or more processors, one or more actions; and
responsive to the determined intent of the at least one communication session not satisfying the predefined attribute, removing, by the one or more processors, the flag on the at least one communication session.

12. The method of claim 11, wherein the at least one characteristic corresponds to a predefined variable comprising at least one of at least one predefined word or at least one predefined phrase.

13. The method of claim 11, wherein the first machine learning model is a natural language processing (NLP) model and the second machine learning model is a large language model.

14. The method of claim 11, wherein the at least one communication session is a textual communication session.

15. The method of claim 11, wherein the filtering is of at least some predefined sensitive data identified in the at least one communication session.

16. The method of claim 11, wherein initiating the one or more actions comprises:
generating, using a third machine learning model, an explanation regarding the determined intent satisfying the predefined attribute; and
sending the generated explanation to at least one user device associated with the at least one communication session.

17. One or more non-transitory computer readable media storing instructions thereon that, when executed by one or more processors, cause the one or more processors to perform operations comprising:
receiving data regarding a plurality of communications sessions;
analyzing, using a first machine learning model, the data to identify at least one characteristic of at least one of the plurality of communication sessions;
flagging the at least one communication session based on identifying the at least one characteristic of the at least one communication session;
filtering at least some data from the at least one communication session of the plurality of communication sessions;
subsequent to filtering the at least some data from the at least one communication session, analyzing, using a second machine learning model, the filtered at least some data from the at least one communication session of the plurality of communication sessions to determine an intent of the at least one communication session;
responsive to the determined intent of the at least one communication session satisfying a predefined attribute, initiating one or more actions; and
responsive to the determined intent of the at least one communication session not satisfying the predefined attribute, removing the flag on the at least one communication session.

18. The one or more non-transitory computer readable media of claim 17, wherein the at least one characteristic corresponds to a predefined variable comprising at least one of at least one predefined word or at least one predefined phrase.

19. The one or more non-transitory computer readable media of claim 17, wherein the filtering is of at least some predefined sensitive data identified in the at least one communication session.

20. The one or more non-transitory computer readable media of claim 17, wherein initiating the one or more actions comprises:
generating, using a third machine learning model, an explanation regarding the determined intent satisfying the predefined attribute; and
sending the generated explanation to at least one user device associated with the at least one communication session.
